(19) United States
(12) Patent Application Publication
(10) Pub. No.: US 2025/0190990 A1
(43) Pub. Date: Jun. 12, 2025

(54) Transaction System with Trusted Parties

(71) Applicant: BAM Enterprises of Amarillo LLC, Amarillo, TX (US)

(72) Inventors: Bradley Veazey, Amarillo, TX (US); Eduardo Fragoso, Amarillo, TX (US); Martin Lewis, Plainview, TX (US)

(21) Appl. No.: 19/051,164

(22) Filed: Feb. 11, 2025

Related U.S. Application Data
(60) Provisional application No. 63/608,728, filed on Dec. 11, 2023.

(51) Int. Cl. G06Q 20/40; G06Q 20/02; G06V 40/16; G06V 40/40; H04L 9/08

(52) U.S. Cl. CPC G06Q 20/40145; G06Q 20/023; G06V 40/172; G06V 40/40; H04L 9/085

(57) ABSTRACT

A method of securing commercial transactions in a commercial transaction system, the method is disclosed. Comprising creating, using a customer device and a sales system server, a customer account associated with a customer using an account creation procedure comprising at least: receiving information related to the customer in a basic account creation step, capturing a government ID image data in an ID scanning step, capturing a captured biometric data of the customer during a facial scanning step, and comparing the government ID image data and the captured biometric data to verify a match related to the customer, and creating a verification algorithm representing a verification of the customer using the commercial transaction system. Creating a verification token, using the customer device and the sales system server.

### CROSS-REFERENCE TO RELATED APPLICATIONS

This application claims the benefit of U.S. Provisional Application No. 63/608,728, filed on Dec. 11, 2023, under 35 U.S.C. § 119(e). A petition to restore the benefit claim is included with this filing, as this application has been submitted within 14 months from the provisional application's filing date rather than the standard 12-month period. The delay in filing was unintentional, and the petition is made pursuant to 37 CFR 1.78(b).

### STATEMENT REGARDING FEDERALLY SPONSORED RESEARCH OR DEVELOPMENT (IF APPLICABLE)

Not applicable.

### REFERENCE TO SEQUENCE LISTING, A TABLE, OR A COMPUTER PROGRAM LISTING COMPACT DISC APPENDIX (IF APPLICABLE)

Not applicable.

### BACKGROUND OF THE INVENTION

Conventional payment systems provide several layers of security for electronic transactions, often relying on card verification values (CVV codes), personal identification numbers (PINs), or device-based biometrics such as a simple face or fingerprint unlock. However, these mechanisms typically establish the user's identity only once—during initial account setup—or rely on minimal checks at the time of payment (e.g., ensuring a device is unlocked). As a result, fraud may still occur when an unauthorized person gains access to a user's unlocked phone, password, or payment card.

Moreover, traditional systems rarely compare a user's real-time biometric data to an official government-issued ID once the account is created. Even robust device-level biometric checks do not necessarily validate that the person holding the device is the same legal individual who initially provided a driver's license or passport. This gap allows impostors to pass themselves off as legitimate users, especially when system alerts are not triggered at the moment of transaction.

The present invention addresses these problems by implementing a pre-transaction identity verification step that re-checks a user's face, comparing it against an earlier scan of the individual's government ID. This verification is performed in tandem with a split-credential approach that prevents full payment data from residing on any one device or server in unencrypted form. By requiring a live biometric match each time a sensitive transaction occurs, the system significantly reduces fraudulent activity and unauthorized account usage. It can also integrate with standard payment clearing networks while meeting know-your-customer (KYC) obligations and other regulatory requirements.

In addition, the use of AI-driven transaction monitoring can further enhance overall fraud prevention by identifying unusual spending patterns or geographic anomalies in real time, supplementing the already robust biometric and split-credential security model.

### BRIEF SUMMARY OF THE INVENTION

A method of securing commercial transactions 400 in a commercial transaction system 100, said method is disclosed. Comprising creating, using a customer device 120 and a sales system server 108, a customer account 508 associated with a customer 104a using an account creation procedure 402 comprising at least: receiving information related to said customer 104a in a basic account creation step 704, capturing a government ID image data 1604 in an ID scanning step 706, capturing a captured biometric data 1606 of said customer 104a during a facial scanning step 708, and comparing said government ID image data 1604 and said captured biometric data 1606 to verify a match related to said customer 104a, and creating a verification algorithm 1608 representing a verification of said customer 104a using said commercial transaction system 100. creating a verification token 1806, using said customer device 120 and said sales system server 108, for a transaction associated with said customer 104a using a pre-transaction identity verification procedure 404 comprising at least: initiating a transaction, having a transaction data package 522, using said customer device 120, capturing an updated version of said captured biometric data 1606 using said customer device 120, performing a liveliness detection step to verify that said user is physically present. comparing, by said sales system server 108, said captured biometric data 1606 to said verification algorithm 1608 to verify the original party is conducting said transaction, and providing the verification token 1806 provided said captured biometric data 1606 and said verification algorithm 1608 are verified.

A method of use method of securing commercial transactions 400 in the commercial transaction system 100, said method is disclosed. Comprising detecting, by the sales system server 108, a trigger condition indicative of a high-risk or regulated transaction initiated by a user holding a previously created account. prompting, at the customer device 120, said user to perform a pre-transaction identity verification including a live facial scan. comparing, by said sales system server 108, said live facial scan to a stored biometric profile of said user created during the account creation procedure 402. proceeding with a transaction approval process only if said stored biometric profile matches said live facial scan above a predetermined confidence threshold.

The commercial transaction system 100 configured to implement the method of securing commercial transactions 400 for pre-transaction identity verification, the system is disclosed. Comprising the customer device 120 having a device application 124 adapted to capture a user's facial image and transmit said facial image to the sales system server 108. said sales system server 108 storing a biometric profile of said user in an identity verification database 608, said biometric profile having been generated during the account creation procedure 402. wherein said sales system server 108 compares a newly captured facial image to said biometric profile upon detecting an attempted transaction, and authorizes said attempted transaction only if said newly captured facial image matches said biometric profile.

### BRIEF DESCRIPTION OF THE SEVERAL VIEWS OF THE DRAWING

FIG. 1 illustrates a flow diagram of a commercial transaction system 100.

FIG. 2A illustrates an elevated overview of a merchant store 200 with said point-of-sale system 110 and said customer device 120.

FIG. 2B illustrates said check-out counter 202 with a payment card transaction 232.

FIG. 3 illustrates an existing transaction clearing system 300.

FIG. 4 illustrates a flow chart view of a method of securing commercial transactions 400.

FIG. 5 illustrates a block diagram of said point-of-sale system 110, said sales system server 140 and said customer device 120 interacting under said commercial transaction system 100.

FIG. 6 illustrates a block diagram 620 of said sales system server 140 which can manage regulation logs, identity checks, jurisdiction rules, and licensing requirements.

FIG. 7 illustrates the account creation procedure 402.

FIG. 8 illustrates the split knowledge setup procedure 800.

FIGS. 9-10 illustrate a data flow diagram 900 of said split knowledge setup procedure 800.

FIG. 11 comprising a payment credential reconstruction procedure 1100, showing how said sales system server 108 reassembles the credential.

FIG. 12-14 illustrate said payment credential reconstruction procedure 1100.

FIG. 15 illustrates a method of periodically changing encryption keys 1500, describing how said commercial transaction system 100 can cycle through updated encryption key 834 values to prevent prolonged cryptographic exposure.

FIG. 16 illustrates a new account data flow diagram 1600.

FIG. 17 illustrates the pre-transaction identity verification procedure 404.

FIG. 18 illustrates a pre-transaction identity verification data flow diagram 1800.

### DETAILED DESCRIPTION OF THE INVENTION

The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

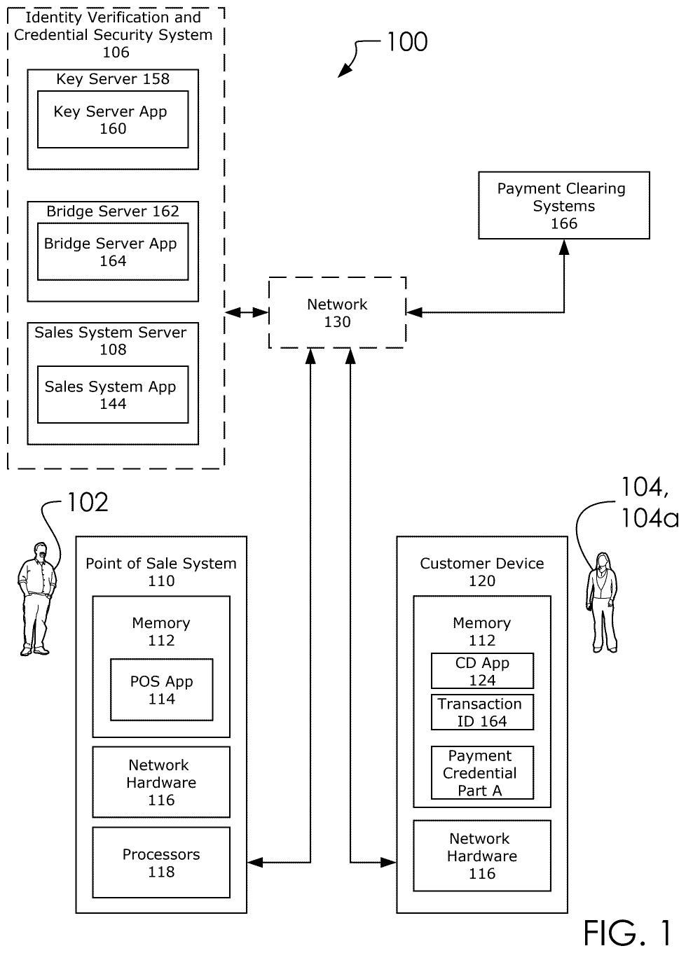

FIG. 1 illustrates a flow diagram of a commercial transaction system 100.

In one embodiment, said commercial transaction system 100 can comprise communication between a merchant 102, one or more consumers 104 and an identity verification and credential security system 106. Said one or more consumers 104 can comprise a customer 104a.

In one embodiment, said merchant 102 can interact with said commercial transaction system 100 using a point-of-sale system 110; and said one or more consumers 104 can interact with said commercial transaction system 100 using a customer device 120. In one embodiment, said point-of-sale system 110 can comprise a digital register such as an iPad running a checkout system software, or similar. In one embodiment, said customer device 120 can comprise a smartphone or digital tablet.

In one embodiment, said identity verification and credential security system 106 can comprise a sales system server 108 having a sales system application 144, a key server 158 having a key server application 160, and a bridge server 162 having a bridge server application 164.

In one embodiment, said point-of-sale system 110 can comprise a POS application 114; and said customer device 120 can comprise a device application 124.

It is understood that said sales system server 108, said point-of-sale system 110, said customer device 120, a sales system server 140, said key server 158 and said bridge server 162 can each comprise a computer having at least a memory 112 and a network hardware 116, and one or more processors 118. Wherein, said memory 112 can store data; and the combination of said memory 112 and said one or more processors 118 can store and executable programs such as said POS application 114, said device application 124, said sales system application 144, said key server application 160 and said bridge server application 164. Likewise, it is understood that the computers utilized in said commercial transaction system 100 can communicate over a network 130 comprising public and private networks, LANs, WANs, the internet, and the like.

In one embodiment, said commercial transaction system 100 can be configured to secure transactions between said merchant 102 and said one or more consumers 104 utilizing said identity verification and credential security system 106 prior to sending payment credentials to a payment clearing system 166. In one embodiment, said payment clearing system 166 can comprise a bank network, credit card network, online payment platform or similar.

In one embodiment, said commercial transaction system 100 can comprise interaction between the merchant 102 operating the point-of-sale system 110 and one or more one or more consumers 104 operating the customer device 120. Said commercial transaction system 100 can further comprise the identity verification and credential security system 106 having multiple servers, including the sales system server 108, the bridge server 162, and the key server 158. Each server can run respective software applications that handle transaction processing, biometric verification, and, optionally, split-credential storage across the network 130.

Said merchant 102 can be any retail or service provider equipped with said point-of-sale system 110. In one embodiment, said point-of-sale system 110 can comprise the POS application 114 running on a local computing device such as a tablet or register. Said one or more consumers 104 can each use a personal device, referred to as said customer device 120, which may include a smartphone or similar. In one embodiment, said customer device 120 runs the device application 124 that handles both initial account creation and subsequent pre-transaction identity verifications.

In one embodiment, said identity verification and credential security system 106 can be configured to ensure a user's identity is verified prior to reconstructing any payment credentials for submission to the payment clearing system 166. This approach addresses shortcomings in existing payment systems by confirming that a user requesting a transaction is the same individual who initially enrolled, thereby reducing fraud.

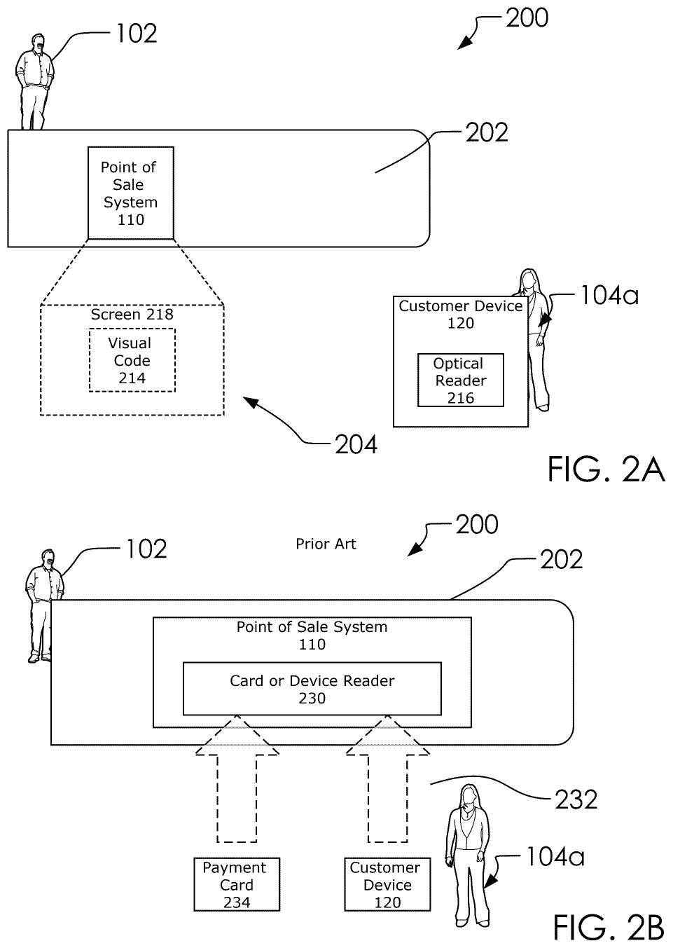

FIG. 2A illustrates an elevated overview of a merchant store 200 with said point-of-sale system 110 and said customer device 120.

In one embodiment, said commercial transaction system 100 can be implemented in a retail store, restaurant, or similar venue where said one or more consumers 104 and said merchant 102 would traditionally transact commerce. In one embodiment, said one or more consumers 104 can have said point-of-sale system 110 on a check-out counter 202; whereupon said one or more consumers 104 would present selected merchandise for purchase, pay said merchant 102 and thereafter leave with the merchandise.

In one embodiment, said one or more consumers 104 can set up an account with said sales system application 144, including payment methods, personal records, and all requirements under the KYC regulations, as discussed in the Background section of this application. Whereupon said commercial transaction system 100 can meet all regulatory requirements for said merchant 102 and said one or more consumers 104 to interact, even where said merchant 102 is not given unnecessary access to information about said one or more consumers 104. Thereby, said merchant 102 can rely on said sales system server 108 to establish a known customer dossier, and focus on the quality of his merchandise, pricing and customer service.

In one embodiment, said merchant 102 can collect shopping data such as time spent in said merchant store 200, location within said merchant store 200, items considered, and transaction total, all without gathering personally identifiable information about said one or more consumers 104. Thereby, said merchant 102 can improve his store without invading the privacy of said one or more consumers 104.

In one embodiment, said point-of-sale system 110 can comprise a visual code 220 which can be read by an optical reader 216 of said customer device 120. Said visual code 220 can comprise a QR code on a computer screen 218 and said optical reader 216 can comprise a camera.

In one embodiment, said device application 124 can activate a GPS or other communication device to verify the location of said one or more consumers 104 and said point-of-sale system 110, as is known in the art. Such signals can enhance said commercial transaction system 100 and the interaction between said merchant 102 and said one or more consumers 104.

Said customer device 120 can be used by said one or more consumers 104 to select products and then approve a payment.

In one embodiment, the device application 124 prompts the user to perform a face scan at the counter to verify identity prior to releasing final payment approval.

FIG. 2B illustrates said check-out counter 202 with a payment card transaction 232.

Likewise, said merchant store 200 is ill-equipped to manage complex transactions in the KYC space. Consider a card-device reader in said point-of-sale system 110, as is known in the art, for a user to interact with a card-device reader 230, a localized data transfer between said point-of-sale system 110 and said customer device 120 or a payment card 234 must be transacted. a localized data transfer can comprise a magnetic card read, or chip read from a payment card, or similar transfer from said customer device 120. Wherein, a payment card represents a data vulnerability where fraud and theft can occur, victimizing said merchant 102 or said one or more consumers 104.

Accordingly, said commercial transaction system 100 can be configured to establish a verifiable relationship between said merchant 102 and said one or more consumers 104, to maintain a regulatory KYC paper trail, and clear transactions without data vulnerability in a localized data transfer.

Even when a user swipes or taps a card at the point of sale, said commercial transaction system 100 can enhance security by re-checking the user's live facial image against previously captured biometrics.

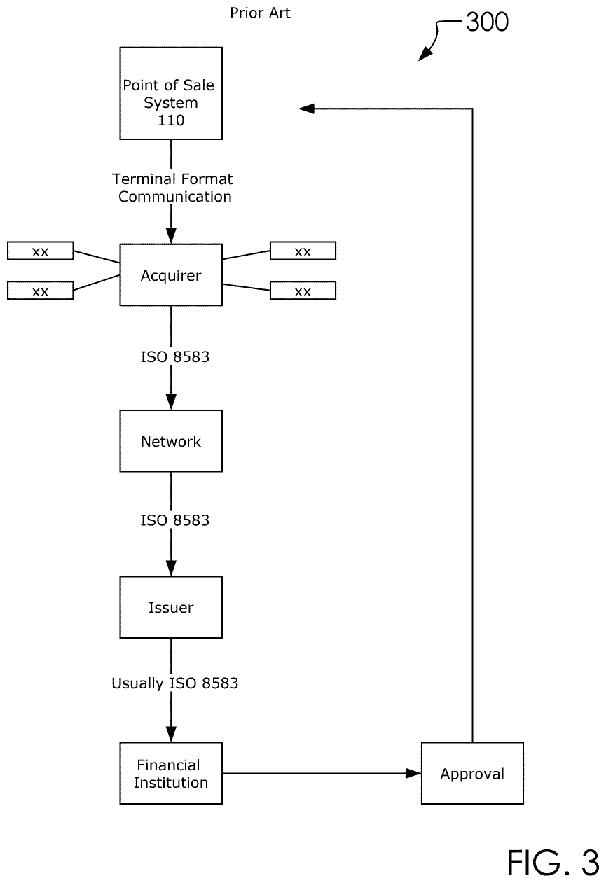

FIG. 3 illustrates an existing transaction clearing system 300.

In one embodiment, said existing transaction clearing system 300 can describe the path of clearing a transaction from said point-of-sale system 110 to an acquirer, to a clearing network, to an issuer, to a financial institution, and then the return trip of the approval to said point-of-sale system 110. In said existing transaction clearing system 300 a transaction may circulate through a plurality of intermediaries for the sake of security and financial accountability, as is known in the art.

Although said existing transaction clearing system 300 is quite robust, it was not designed around the management of customers and vendors who must maintain a know your customer “KYC” relationship. An end user could easily give his credit card to a friend to purchase goods and services at a merchant, rarely does the merchant verify the identity of or signature of a customer, despite the collection of signatures.

In conventional payment flows, transactions usually clear through acquirers and financial institutions with only partial attention to whether the actual card or device holder is the legitimate user. By contrast, said commercial transaction system 100 integrates a robust pre-transaction biometric verification step to mitigate fraud.

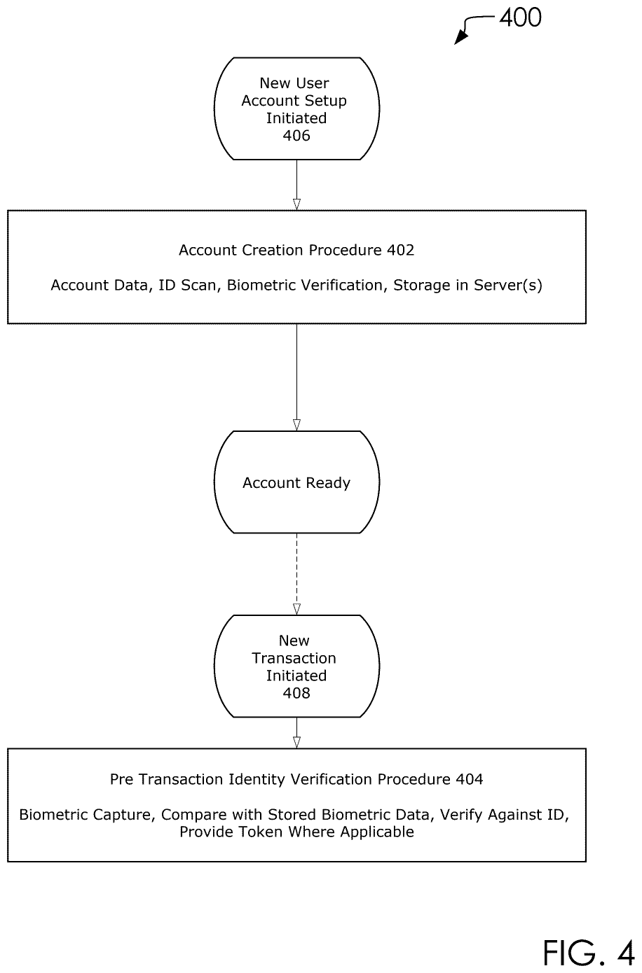

FIG. 4 illustrates a flow chart view of a method of securing commercial transactions 400.

In one embodiment, said method of securing commercial transactions 400 can comprise an account creation procedure 402, a pre-transaction identity verification procedure 404, and a split knowledge setup procedure 800, as discussed herein.

Said method of securing commercial transactions 400 can apply to said commercial transaction system 100. A general overview is provided beginning with a new user account setup trigger 406, said account creation procedure 402, and later, a new transaction initiated step 408, followed by said pre-transaction identity verification procedure 404. Additional details are provided below for these steps.

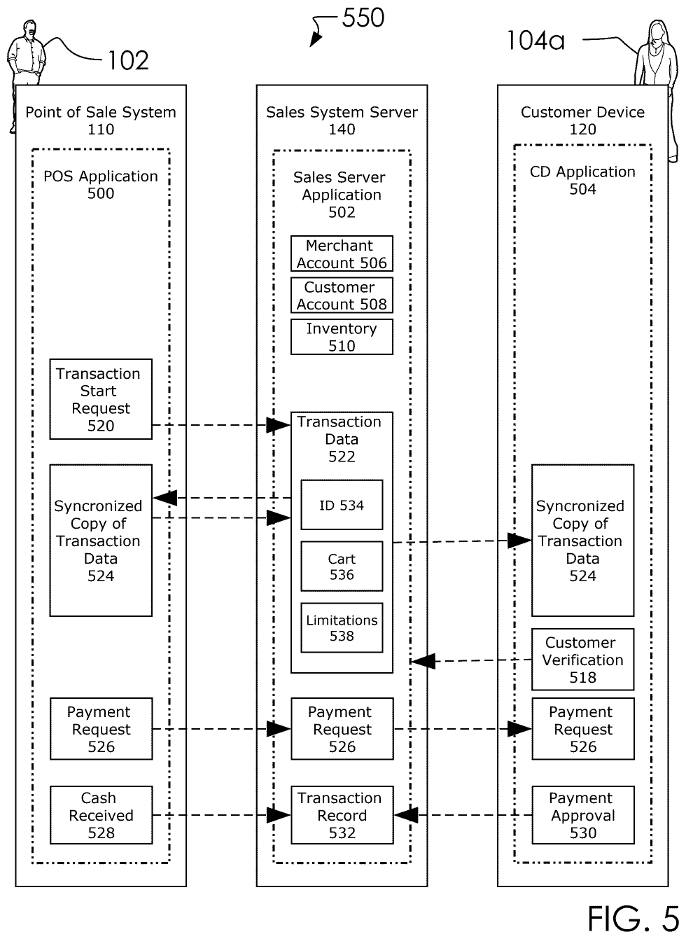

FIG. 5 illustrates a block diagram of said point-of-sale system 110, said sales system server 140 and said customer device 120 interacting under said commercial transaction system 100.

In one embodiment, said commercial transaction system 100 can comprise said point-of-sale system 110 having said one or more consumers 104, said sales system server 140 having said sales system application 144, and said customer device 120 having said device application 124. As is known in the art, said device application 124 can be installed on said merchant 102 by said one or more consumers 104 and configured to interact with said sales system server 140.

In one embodiment, said sales system application 144 can be configured to maintain a merchant account 506 associated with one or more of said merchant 102 and a customer account 508 associated with said one or more consumers 104. Said merchant account 506 can maintain an inventory 510 associated with merchandise available from said merchant 102.

In one embodiment, said device application 124 can interview said one or more consumers 104 while creating said customer account 508 according to account creation procedure 402, as discussed below.

In one embodiment, a transaction method 550 can comprise verifying an identity of the customer 104a among said one or more consumers 104 using a customer verification method 518 in said device application 124, creating a transaction start request 520 with said device application 124 and sending said transaction start request 520 to said sales system application 144, creating a transaction data package 522 with said sales system server 140 associated with a new transaction between said customer 104a and said merchant 102, creating a synchronized copy 524 of said transaction data package 522 on said device application 124 and said one or more consumers 104, updating said transaction data package 522 as said customer 104a shops, initiating a payment request 526 on said one or more consumers 104 when said customer 104a is finished shopping, transmitting said payment request 526 from said one or more consumers 104 to said sales system application 144 to said device application 124, entering either a cash received signal 528 from said one or more consumers 104 or a payment approval 530 from said device application 124, and recording a transaction record 532 in said sales system application 144.

In one embodiment, said sales system server 140 can comprise a transaction ID 534, a shopping cart 536, and a shopping limitations parameters 538. In one embodiment, said transaction ID 534 can comprise a unique identifier of said transaction data package 522, and said shopping cart 536 can comprise a list of merchandise purchased by said customer 104a. Said shopping limitations parameters 538 can comprise a list of limitations on purchases by said customer 104a, such as regulatory limits on purchasing. In one embodiment, said shopping limitations parameters 538 can be tied to a state limitation on drug purchasing by a user in a given time, such as a day, week, month, or year. In one embodiment, said commercial transaction system 100 can be configured to update said shopping limitations parameters 538 based on past purchases by said customer 104a at one or more among said merchant 102.

In one embodiment, said inventory 510 can be maintained based on inputs from said merchant 102 and sales collected in said transaction record 532.

In one embodiment, said transaction ID 534 and said transaction start request 520 can be created automatically when said point-of-sale system 110 establish contact with one another.

By moving said payment approval 530 away from a localized data transfer, said commercial transaction system 100 is configured to eliminate a data vulnerability between said customer device 120, said payment card 234 and said card-device reader 230.

Before any final payment credential is reconstructed or authorized, a pre-transaction biometric match can be performed.

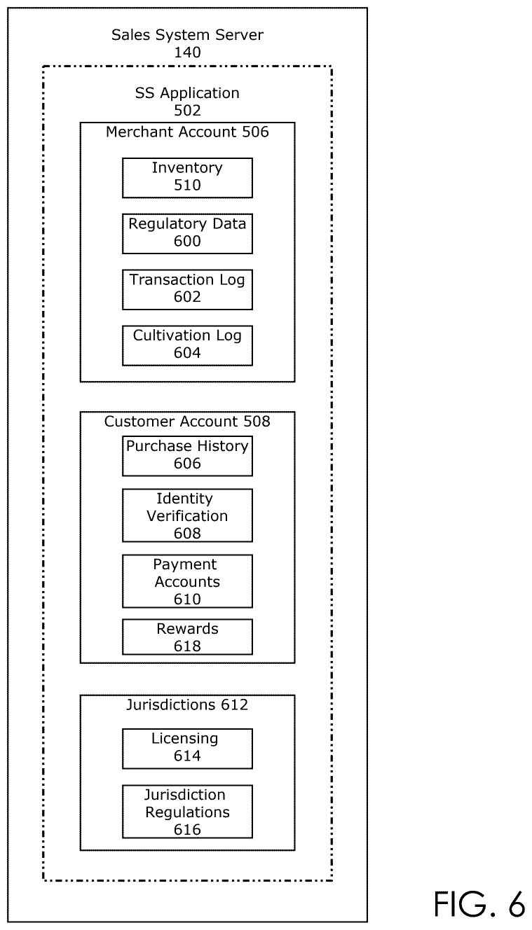

FIG. 6 illustrates a block diagram 620 of said sales system server 140 which can manage regulation logs, identity checks, jurisdiction rules, and licensing requirements.

In one embodiment, said merchant account 506 can comprise said inventory 510, a regulatory database 600, a transaction log 602, and a cultivation log 604. Wherein, said regulatory database 600 can comprise a set of rules associated with said merchant 102 in its jurisdiction. Said transaction log 602 can comprise a database of said transaction record 532 having been previously recorded. Said cultivation log 604 can comprise a record of merchandise being grown by or for said merchant 102.

Each said one or more consumers 104 can comprise a set of records in said customer account 508 associated with their interactions with said commercial transaction system 100. Said customer account 508 can comprise a purchase history 606, an identity verification database 608, and a payment accounts database 610. Said identity verification database 608 can comprise a set of records associated with KYC requirements.

In one embodiment, said sales system server 140 can further comprise a jurisdiction database 612. In one embodiment, said commercial transaction system 100 can be configured to maintain a set of requirements associated with locations and governing authority over said merchant 102. One such regulatory environment can comprise a state legislator and its regulatory environment. Wherein, said commercial transaction system 100 can maintain growing rules, allotment tracking, inventory rules, sales limitations, and similar, which said merchant 102 should maintain a paper trail. Said jurisdiction database 612 can comprise a licensing requirements 614 and a jurisdiction regulations 616. In one embodiment, said commercial transaction system 100 can verify the legality of said transaction data package 522 and update said shopping limitations parameters 538 by referring to said licensing requirements 614, and said jurisdiction regulations 616.

Another example of data tracked in said jurisdiction database 612 can comprise Patriot Act requirements, FinCEN, OFAC and Cole Memorandum requirements. Likewise, due diligence requirements under KYC rules can comprise registered money services businesses, encryption standards, identity verification for said merchant 102 and said one or more consumers 104, bank secrecy act and FinCEN. Additionally, controlled substances regulations such as HIPAA, DEA regulations, looping prevention and allotments, can be managed by said commercial transaction system 100.

In one embodiment, said customer account 508 can comprise a customer rewards account 618 such as a customer loyalty program, or similar, as is known in the art.

In one embodiment, said payment accounts database 610 can comprise a gift cart balance, credit, coupons, or similar.

One advantage of said commercial transaction system 100 is the elimination of a third-party processor, as seen in said existing transaction clearing system 300.

In one embodiment, said customer account 508 can be set up by said sales system application 144 and said device application 124 with inputs from said one or more consumers 104. Wherein, said commercial transaction system 100 can be configured to collect data with reference to said jurisdiction database 612, maintain privacy and said jurisdiction regulations 616, as discussed herein.

In one embodiment, said sales system server 140 verifies that a particular purchase does not violate any state or local regulatory limits. the transaction log 602 records completed purchases, while the purchase history 606 tracks each user's activity.

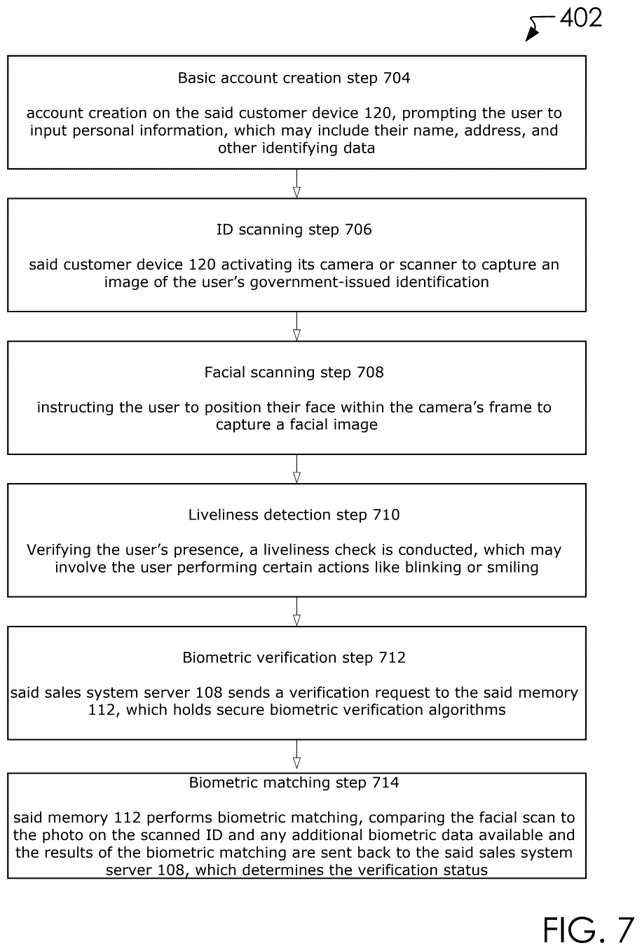

FIG. 7 illustrates the account creation procedure 402.

In one embodiment, said account creation procedure 402 can be implemented by said commercial transaction system 100 in software, such as said POS application 114, said device application 124 and said sales system application 144.

Said account creation procedure 402 can comprise a plurality of account creation and verification steps 702 which can include a basic account creation step 704 including account creation on said customer device 120, prompting the user to input personal information, which may include their name, address, and other identifying data; an ID scanning step 706 which can comprise said customer device 120 activating its camera or scanner to capture an image of the user's government-issued identification; a facial scanning step 708 comprising instructing the user to position their face within the camera's frame to capture a facial image; a liveliness detection step 710 comprising verifying the user's presence, a liveliness check is conducted, which may involve the user performing certain actions like blinking or smiling; a biometric verification step 712 wherein, said sales system server 108 sends a verification request to said memory 112, which holds secure biometric verification algorithms; a biometric matching step 714 comprising said memory 112 performs biometric matching, comparing the facial scan to the photo on the scanned ID and any additional biometric data available and the results of the biometric matching are sent back to said sales system server 108, which determines the verification status. In one embodiment, said facial scanning step 708 can comprise using 3D imaging technology to create a depth map of the user's face.

In one embodiment, account creation procedure 402 can comprise a new user registering by providing personal data, scanning a government-issued ID (ID scanning step 706), capturing a facial image (facial scanning step 708), performing a liveliness check (liveliness detection step 710), and undergoing the biometric matching step 714. Once validated, said sales system server 108 (or said sales system server 140) stores these biometrics for repeated verification.

By matching a live image of said customer 104a with ID scanning step 706, said commercial transaction system 100 knows that the party setting up an account is indeed the party on the government ID from said ID scanning step 706.

In one embodiment, said account creation procedure 402 can further comprise comparing an image from said ID scanning step 706 with verified records in a government database. For example, comparing data on a scanned ID with data from an ID issuer database to verify the authenticity of a scanned image of an ID.

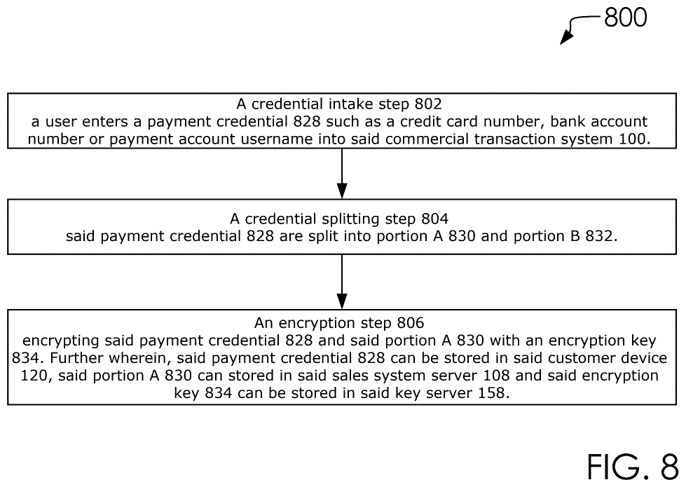

FIG. 8 illustrates the split knowledge setup procedure 800.

In one embodiment, said split knowledge setup procedure 800 can comprise a plurality of steps as outlined to follow. A credential intake step 802 which can comprise a user enters a payment credential 828 such as a credit card number, bank account number or payment account username into said commercial transaction system 100. A credential splitting step 804 wherein, said payment credential 828 are split into portion A 830 and portion B 832. An encryption step 806 which can comprise encrypting said payment credential 828 and said portion A 830 with an encryption key 834. Further wherein, said payment credential 828 can be stored in said customer device 120, said portion A 830 can stored in said sales system server 108 and said encryption key 834 can be stored in said key server 158.

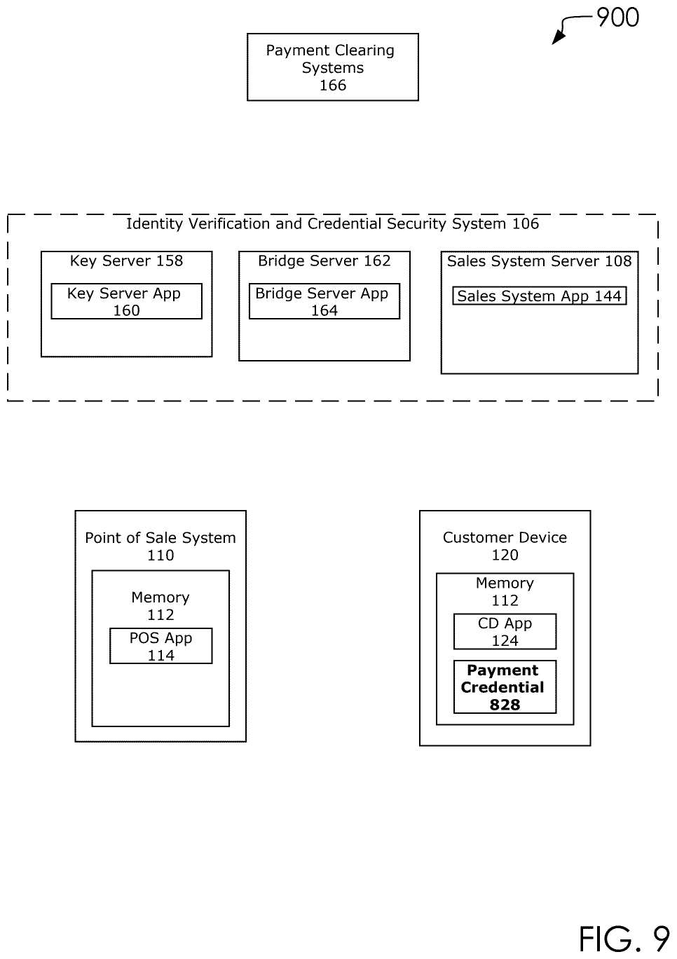

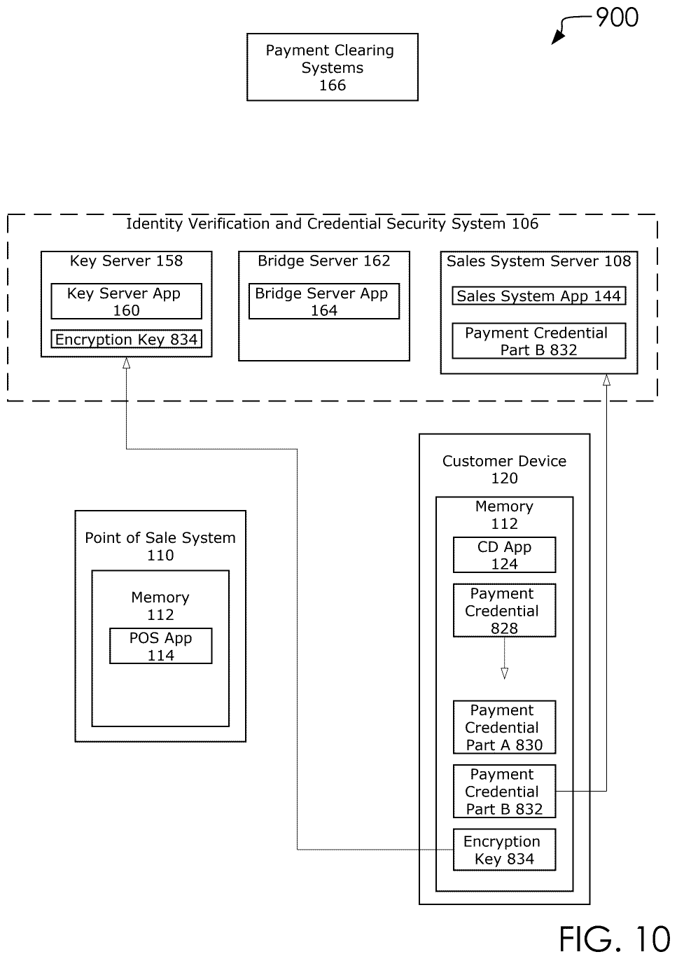

FIGS. 9-10 illustrate a data flow diagram 900 of said split knowledge setup procedure 800.

As discussed in said split knowledge setup procedure 800, said commercial transaction system 100 can be configured for receiving said payment credential 828 from a user and splitting it up into said portion A 830, said portion B 832 and said encryption key 834. Wherein, said portion B 832 can be passed to said sales system server 108, said encryption key 834 to said key server 158 and said portion A 830 kept in said customer device 120. Thereafter, said memory 112 of said customer device 120 can delete records of said portion B 832 and said encryption key 834 for security purposes.

Said commercial transaction system 100 can receive, store, and protect sensitive payment data so that the complete credential never resides in unencrypted form on any single device.

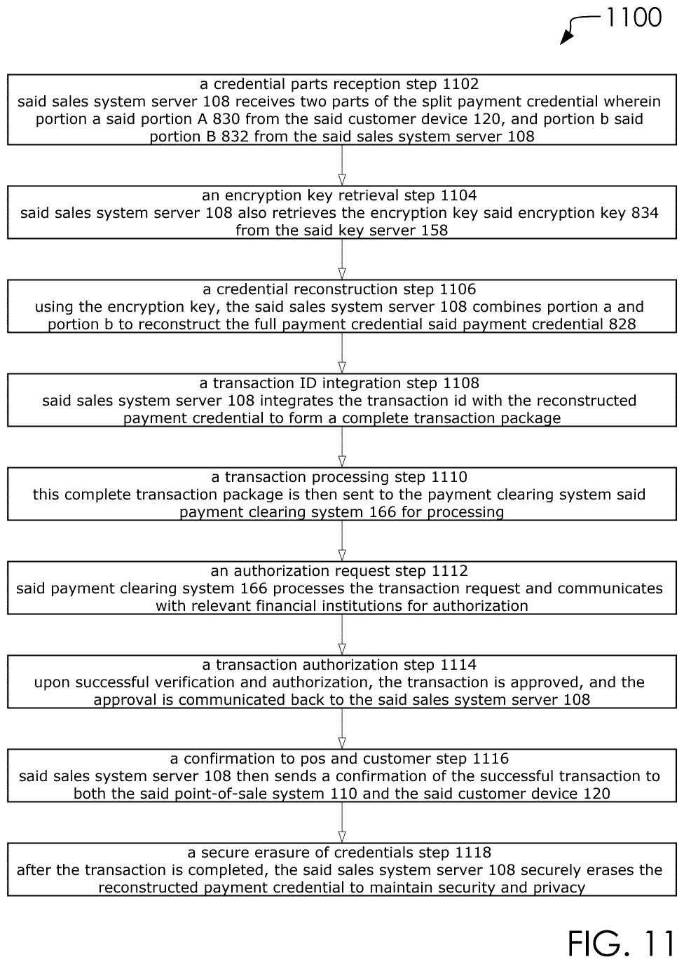

FIG. 11 comprising a payment credential reconstruction procedure 1100, showing how said sales system server 108 reassembles the credential.

Wherein, said payment credential reconstruction procedure 1100 can comprise a credential parts reception step 1102 wherein said sales system server 108 receives two parts of the split payment credential wherein portion a said portion A 830 from said customer device 120, and portion b said portion B 832 from said sales system server 108; an encryption key retrieval step 1104 wherein said sales system server 108 also retrieves the encryption key said encryption key 834 from said key server 158; a credential reconstruction step 1106 wherein using the encryption key, said sales system server 108 combines portion a and portion b to reconstruct the full payment credential said payment credential 828; a transaction ID integration step 1108 wherein said sales system server 108 integrates the transaction id with the reconstructed payment credential to form a complete transaction package; a transaction processing step 1110 wherein this complete transaction package is then sent to the payment clearing system said payment clearing system 166 for processing; an authorization request step 1112 wherein said payment clearing system 166 processes the transaction request and communicates with relevant financial institutions for authorization; a transaction authorization step 1114 wherein upon successful verification and authorization, the transaction is approved, and the approval is communicated back to said sales system server 108; a confirmation to POS and customer step 1116 wherein said sales system server 108 then sends a confirmation of the successful transaction to both said point-of-sale system 110 and said customer device 120; and a secure erasure of credentials step 1118 wherein after the transaction is completed, said sales system server 108 securely erases the reconstructed payment credential to maintain security and privacy.

As discussed below, said payment credential reconstruction procedure 1100 further comprises a pre-transaction facial verification step must first confirm the user's identity before said sales system server 108 can retrieve or decrypt portion A 830 and portion B 832.

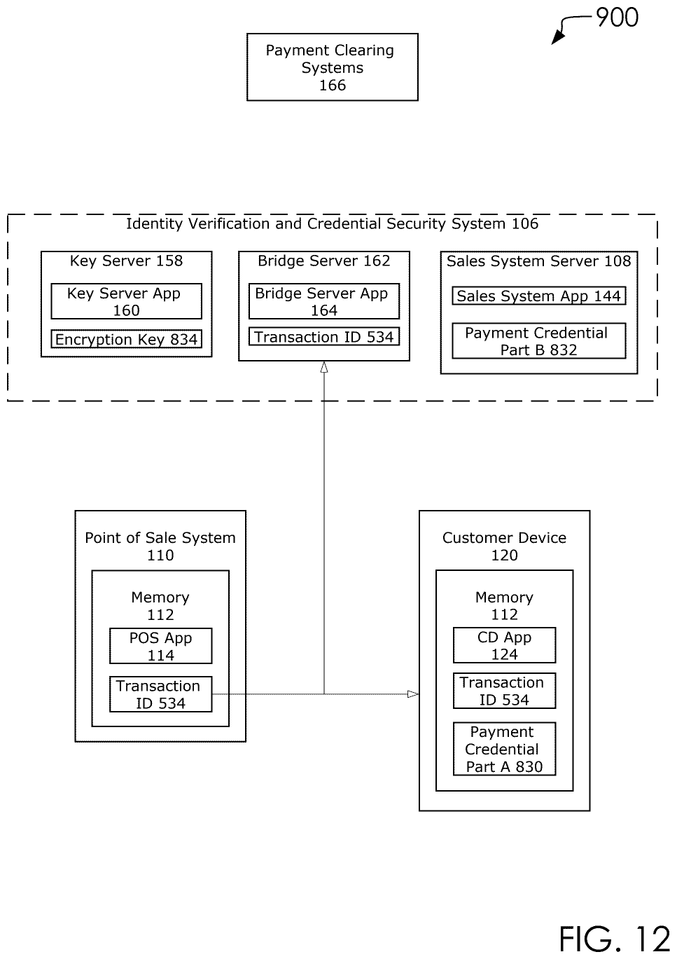

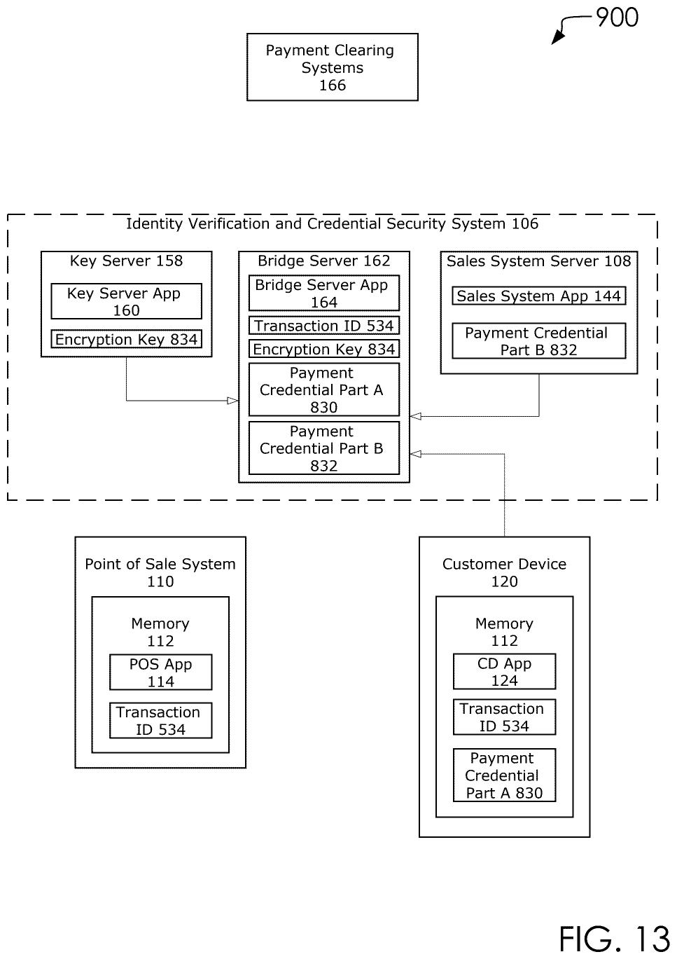

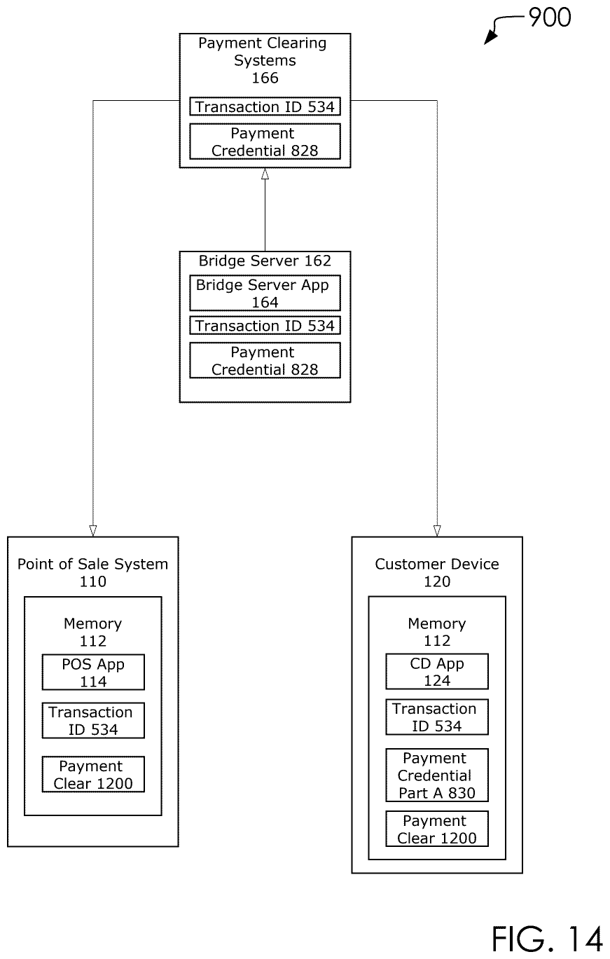

FIG. 12-14 illustrate said payment credential reconstruction procedure 1100.

Once authorized, the confirmation to POS and customer step 1116 notifies both said point-of-sale system 110 and said customer device 120, and said sales system server 108 can securely erase the reconstructed credential.

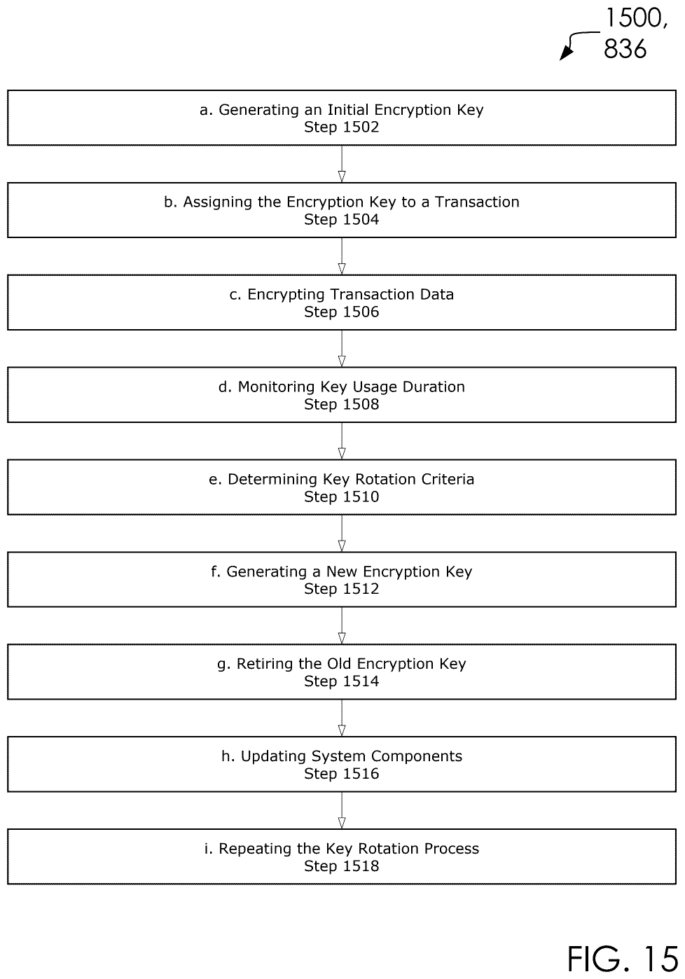

FIG. 15 illustrates a method of periodically changing encryption keys 1500, describing how said commercial transaction system 100 can cycle through updated encryption key 834 values to prevent prolonged cryptographic exposure.

In one embodiment, method of periodically changing encryption keys 1500 can comprise a generating an initial encryption key step 1502 comprising generating an initial encryption key at said memory 112 for use in encrypting transaction data; an assigning the encryption key to a transaction step 1504 comprising assigning the initial encryption key to a transaction initiated by a user via a said customer device 120; an encrypting transaction data step 1506 comprising encrypting transaction data using the assigned encryption key at either said customer device 120, said point-of-sale system 110, or said sales system server 108; a monitoring key usage duration step 1508 comprising continuously monitoring the duration for which the encryption key has been in use by said memory 112; a determining key rotation criteria step 1510 comprising determining when to rotate the encryption key based on predefined criteria, such as time elapsed, number of transactions processed, or detection of potential security threats; a generating a new encryption key step 1402 comprising generating a new encryption key at said memory 112 upon meeting the rotation criteria; a retiring the old encryption key step 1550 comprising securely retiring the old encryption key and updating relevant components of the system, including said customer device 120, said point-of-sale system 110, and said sales system server 108 with the new encryption key; an updating system components step 1104a comprising communicating the new encryption key to the relevant components of the commercial transaction system (100), ensuring continuous protection of transaction data; and a repeating the key rotation process step 1518 comprising repeating the process of key rotation at regular intervals or based on specific triggers to maintain dynamic security within the system.

Finally, said commercial transaction system 100 can be employed to protect against fraudulent transactions using machine learning and AI. For example, by utilizing data from various components such as said customer device 120, said point-of-sale system 110, and said sales system server 140, the AI can employ algorithms to monitor and analyze transactions. Such as behavioral pattern analysis, location based verification, transaction velocity analysis, link analysis for fraud networks and real-time transaction risk assessment.

The AI assesses individual consumer profiles based on historical data from said sales system server 140. It recognizes established spending patterns, preferred merchants, and typical transaction amounts associated with each user's said customer device 120. Anomalies in these patterns could indicate potential fraud.

Likewise, location-based verification can comprise analyzing transaction locations logged by said point-of-sale system 110 and comparing them with the usual locations of said customer device 120, the AI can identify transactions occurring in unusual or unexpected places, potentially signaling unauthorized use.

In one embodiment, said commercial transaction system 100 can be trained for transaction velocity monitoring comprising monitoring the rate and frequency of transactions processed through said sales system server 140. A high frequency or unusual pattern of transactions, especially from the same said customer device 120 but in varied locations, may be flagged for further scrutiny.

Link Analysis for Fraud Networks: The AI employs advanced link analysis techniques to detect networks of fraud. It examines connections between disparate but potentially related transactions across said sales system server 140, identifying patterns that might indicate coordinated fraudulent activity.

Real-Time Transaction Risk Assessment: Each transaction processed through said sales system server 140 and said point-of-sale system 110 is assigned a real-time risk score. This score is based on variables such as transaction amount, location, the device used, and historical data. Transactions with high-risk scores could trigger immediate alerts or require additional authentication steps.

These AI-driven strategies enhance the security framework of said commercial transaction system 100, enabling proactive identification and prevention of fraudulent activities by consumers. The system's dynamic and intelligent approach to fraud detection not only safeguards against current threats but also evolves to counter new and emerging fraudulent tactics.

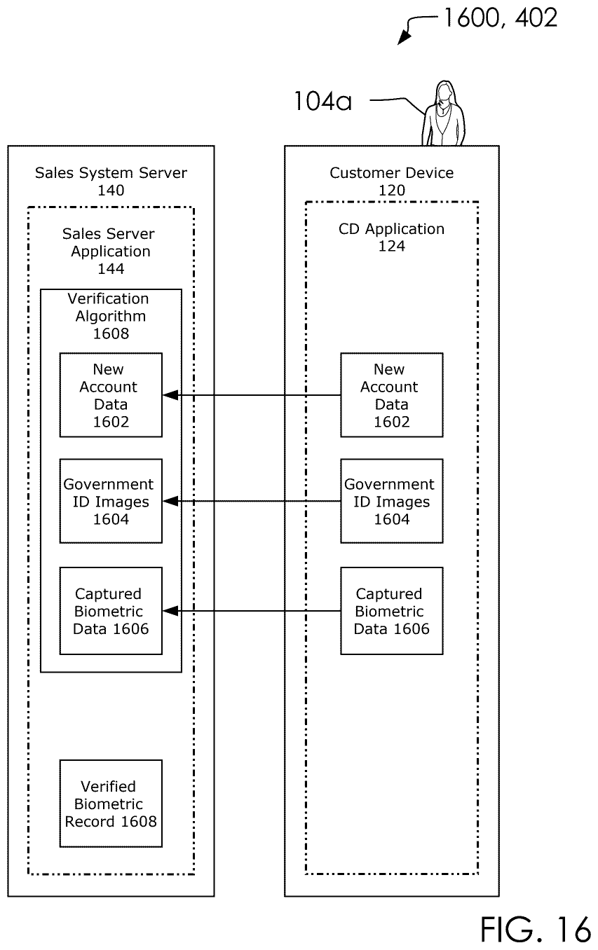

FIG. 16 illustrates a new account data flow diagram 1600.

In one embodiment, said new account data flow diagram 1600 can illustrate said account creation procedure 402 from a data flow perspective.

In one embodiment, said account creation procedure 402 can comprise basic account creation step 704, ID scanning step 706, facial scanning step 708; wherein, said basic account creation step 704 can related to a new account data 1602, said ID scanning step 706 can related to a government ID image data 1604, and said facial scanning step 708 can related to a captured biometric data 1606.

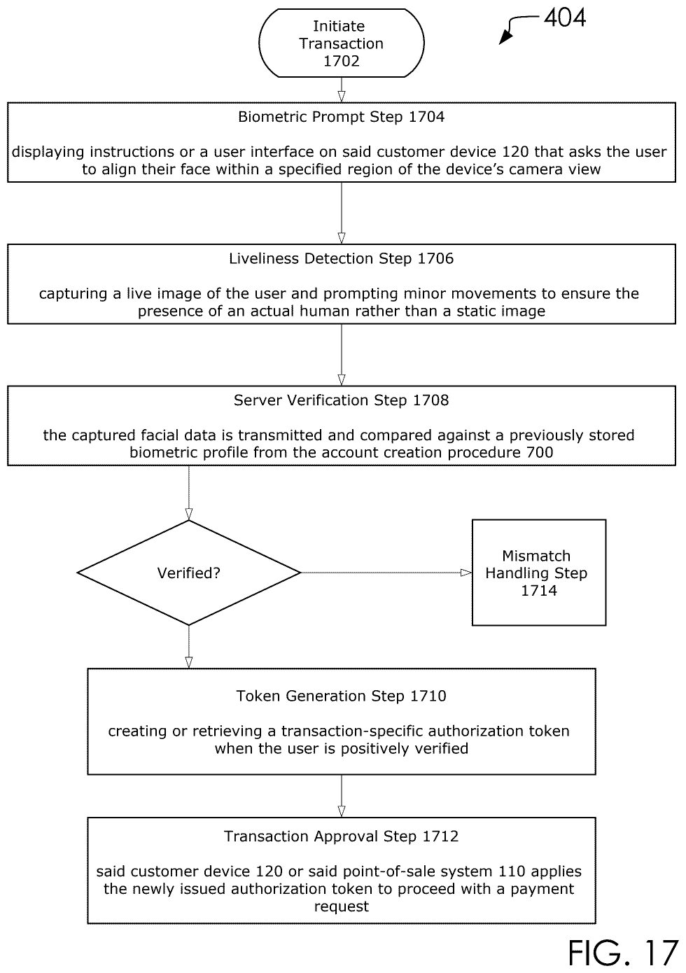

In one embodiment, said 502/can comprise a verification algorithm 1608 configured for: receiving said new account data 1602, government ID image data 1604, and captured biometric data 1606; verifying a match between said new account data 1602 and said government ID image data 1604 in said biometric verification step 712; and creating the verification algorithm 1608. FIG. 17 illustrates the pre-transaction identity verification procedure 404.

In one embodiment, said pre-transaction identity verification procedure 404 can comprise the following steps:

An initiating transaction step 1702 comprising detecting an attempt to initiate a high-value or regulated transaction on the customer device 120, such as when a user selects “pay now” in said device application 124.

A biometric prompt step 1704 comprising displaying instructions or a user interface on said customer device 120 that asks the user to align their face within a specified region of the device's camera view.

A liveliness detection step 1706 comprising capturing a live image of the user and prompting minor movements (e.g., blinking or slowly turning the head) to ensure the presence of an actual human rather than a static image. Said device application 124 analyzes the captured frames to confirm motion.

A server verification step 1708 wherein the captured facial data is transmitted to the sales system server 108 or sales system server 140, which compares the new image against a previously stored biometric profile from the account creation procedure 402. If the match score is above a predetermined threshold, the sales system server 108 deems the user identity verified.

A token generation step 1710 comprising creating or retrieving a transaction-specific authorization token when the user is positively verified. In one embodiment, this token can be stored temporarily on said customer device 120 or directly integrated into the transaction record on said sales system server 108.

A transaction approval step 1712 wherein said customer device 120 or said point-of-sale system 110 applies the newly issued authorization token to proceed with a payment request, triggering the payment credential reconstruction procedure 1100 if split credentials are employed.

A mismatch handling step 1714 comprising a branch in which the transaction is declined or flagged if the biometric comparison fails. Additional steps can include alerting the legitimate account holder or requiring alternative verification methods (e.g., security questions).

By executing these steps, said pre-transaction identity verification procedure 404 confirms that the individual authorizing a transaction is the same user who initially provided government-issued identification and biometric data during account creation. This approach reduces fraud by requiring a fresh facial match before releasing any sensitive payment credentials.

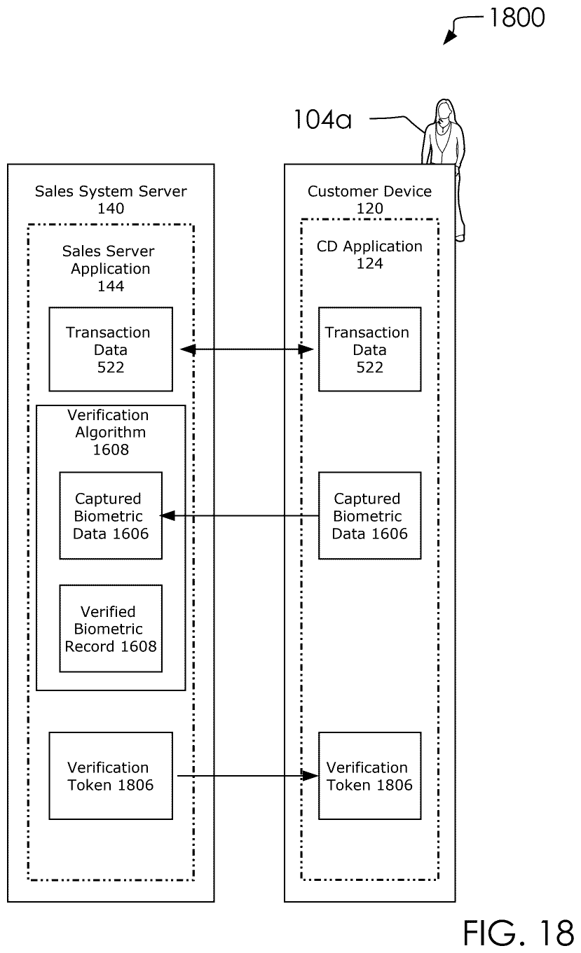

FIG. 18 illustrates a pre-transaction identity verification data flow diagram 1800.

In one embodiment, whenever a user attempts to perform a high-risk or regulated transaction, said customer device 120 prompts the user to repeat a quick facial scan. Said customer device 120 can capture a live image of the user's face and verify motion or blinking. A back-end match then compares the captured biometric data 1606, such as a captured face image, to the verification algorithm 1608 in said identity verification database 608. If the match is successful, the system releases a verification token 1806 or proceeds to reassemble the necessary payment credentials. If the match fails, the transaction is halted, and an alert may be issued to relevant security teams. In one embodiment, comparing said verification algorithm 1608 with said captured biometric data 1606 can be conducted in the verification algorithm 1608.

### Operational Advantages

By combining initial account creation with repeated biometric confirmation at the moment of transaction, said commercial transaction system 100 implements “pre-transaction fraud prevention.” This approach helps ensure that the person completing a payment is indeed the same legally identified individual who enrolled under KYC rules.

Said commercial transaction system 100 thus provides an integrated platform where a user's identity is robustly verified during account setup and re-checked prior to each transaction. This two-stage verification protects against scenarios in which unauthorized persons might obtain access to a device that is merely “unlocked” or that has a stored password. By storing split payment credentials and requiring real-time facial scans, the system mitigates common forms of fraud such as device theft, impersonation, or social engineering attacks.

Furthermore, the “split knowledge” aspect ensures that even if one party's data is compromised—e.g., said customer device 120 is stolen—the attacker still lacks the other credential portion (as well as the encryption key) needed to make fraudulent payments. The repeated biometric verification also reduces the risk of funds being improperly transferred, because an impostor would not satisfy the real-time liveliness detection and facial matching steps.

Although this disclosure repeatedly references retail transactions, said commercial transaction system 100 can be adapted for a variety of use cases, including wire transfers, online banking, building access control, hotel check-in, or any system that benefits from both identity verification and tokenized credential handling. When combined with an AI-driven analysis of user behavior or location data, additional fraud flags can be raised if a user's location or spending pattern deviates significantly from a known profile.

### Parts List

said commercial transaction system 100,
said merchant 102,
said customer 104a,
said one or more consumers 104,
said identity verification and credential security system 106,
said sales system server 108,
said point-of-sale system 110,
said memory 112,
said POS application 114,
said network hardware 116,
said one or more processors 118,
said customer device 120,
said device application 124,
said network 130,
said sales system server 140,
said sales system application 144,
said key server 158,
said key server application 160,
said bridge server 162,
said bridge server application 164,
said payment clearing system 166,
said merchant store 200,
said check-out counter 202,
said optical reader 216,
said computer screen 218,
said visual code 220,
said card-device reader 230,
said payment card transaction 232,
said payment card 234,
said existing transaction clearing system 300,
said method of securing commercial transactions 400,
said account creation procedure 402,
said pre-transaction identity verification procedure 404,
said new user account setup trigger 406,
said new transaction initiated step 408,
said merchant account 506,
said customer account 508,
said inventory 510,
said customer verification method 518,
said transaction start request 520,
said transaction data package 522,
said synchronized copy 524,
said payment request 526,
said cash received signal 528,
said payment approval 530,
said transaction record 532,
said transaction ID 534,
said shopping cart 536,
said shopping limitations parameters 538,
said transaction method 550,
said regulatory database 600,
said transaction log 602,
said cultivation log 604,
said purchase history 606,
said identity verification database 608,
said payment accounts database 610,
said jurisdiction database 612,
said licensing requirements 614,
said jurisdiction regulations 616,
said customer rewards account 618,
said block diagram 620,
said plurality of account creation and verification steps 702,
said basic account creation step 704,
said ID scanning step 706,
said facial scanning step 708,
said liveliness detection step 710,
said biometric verification step 712,
said biometric matching step 714,
said split knowledge setup procedure 800,
said credential intake step 802,
said credential splitting step 804,
said encryption step 806,
said payment credential 828,
said portion A 830,
said portion B 832,
said encryption key 834,
said data flow diagram 900,
said payment credential reconstruction procedure 1100,
said credential parts reception step 1102,
said updating system components step 1104a,
said encryption key retrieval step 1104,
said credential reconstruction step 1106,
said transaction ID integration step 1108,
said transaction processing step 1110,
said authorization request step 1112,
said transaction authorization step 1114,
said confirmation to POS and customer step 1116,
said secure erasure of credentials step 1118,
said generating a new encryption key step 1402,
said method of periodically changing encryption keys 1500,
said generating an initial encryption key step 1502,
said assigning the encryption key to a transaction step 1504,
said encrypting transaction data step 1506,
said monitoring key usage duration step 1508,
said determining key rotation criteria step 1510,
said repeating the key rotation process step 1518,
said retiring the old encryption key step 1550,
said new account data flow diagram 1600,
said new account data 1602,
said government ID image data 1604,
said captured biometric data 1606,
said verification algorithm 1608,
said initiating transaction step 1702,
said biometric prompt step 1704,
said liveliness detection step 1706,
said server verification step 1708,
said token generation step 1710,
said transaction approval step 1712,
said mismatch handling step 1714,
said pre-transaction identity verification data flow diagram 1800, and
said verification token 1806.

The following comprises a summary of the claims from the provisional application to this filing:

Said method of securing commercial transactions 400 using said commercial transaction system 100 can comprise receiving, by said sales system server 108, said payment credential 828 from a user via said customer device 120. Splitting, by said sales system server 108, said payment credential 828 into said portion A 830 stored in said customer device 120 and said portion B 832 stored in said sales system server 108. Encrypting, by said sales system server 108, said portion A 830 and said portion B 832 using said encryption key 834 stored in said key server 158. Deleting, by said customer device 120, records of said portion B 832 and said encryption key 834 for security purposes.

Said method of securing commercial transactions 400 using said commercial transaction system 100 can comprise receiving, by said sales system server 108, said payment credential 828 from a user via said customer device 120. Splitting, by said sales system server 108, said payment credential 828 into said portion A 830 stored in said customer device 120 and said portion B 832 stored in said sales system server 108. Encrypting, by said sales system server 108, said portion A 830 and said portion B 832 using said encryption key 834 stored in said key server 158. Deleting, by said customer device 120, records of said portion B 832 and said encryption key 834 for security purposes.

The step of receiving said payment credential 828 further includes validating the payment credential using a predefined validation algorithm in said sales system server 108.

The step of splitting said payment credential 828 further comprises utilizing a split knowledge algorithm to determine the division of data into said portion A 830 and said portion B 832.

The step of encrypting said portion A 830 and said portion B 832 includes using a public-key encryption method.

Securely storing a backup of said portion A 830 in a remote server for data recovery purposes.

The step of deleting records of said portion B 832 and said encryption key 834 can be followed by a verification process to ensure complete removal of data from said customer device 120.

Generating an initial encryption key at said key server 158. Assigning the initial encryption key to a transaction initiated via said customer device 120. Encrypting transaction data using the assigned encryption key. Monitoring the usage duration of the encryption key. Determining when to rotate the encryption key based on predefined criteria. Generating a new encryption key upon meeting the rotation criteria. Updating system components, including said customer device 120 and said sales system server 108, with the new encryption key.

The step of generating an initial encryption key involves creating a key based on a random number generation algorithm in said key server 158.

The step of monitoring the usage duration of the encryption key includes logging key usage metrics in said memory 112 of said sales system server 108.

The criteria for determining when to rotate the encryption key include analysis of transaction volumes processed through said commercial transaction system 100.

Notifying the user via said customer device 120 upon the generation of a new encryption key.

Updating system components with the new encryption key includes synchronizing the updated key across multiple devices linked to said commercial transaction system 100.

Initiating an account creation process on said customer device 120. Capturing, by said customer device 120, an image of a user's government-issued identification and a facial image of the user. Performing a liveliness detection check to verify the user's presence. Sending a verification request from said sales system server 108 to said memory 112 holding secure biometric verification algorithms. Matching, by said memory 112, the captured facial image against the image on the government-issued identification and determining a verification status.

Receiving, by said bridge server 162, said portion A 830 of the split payment credential from said customer device 120 and said portion B 832 from said sales system server 108. Retrieving, by said bridge server 162, said encryption key 834 from said key server 158. Reconstructing, by said bridge server 162, the full payment credential said payment credential 828 by combining said portion A 830 and said portion B 832 using said encryption key 834. Sending the reconstructed payment credential said payment credential 828 along with said transaction ID 534 from said bridge server 162 to a payment clearing system said payment clearing system 166 for processing. Receiving transaction authorization from said payment clearing system 166 and communicating the successful transaction to both said customer device 120 and said point-of-sale system 110. Securely erasing the reconstructed payment credential from said bridge server 162 upon completion of the transaction to maintain security and privacy.

The step of reconstructing the full payment credential said payment credential 828 further comprises verifying the integrity of both said portion A 830 and said portion B 832 before recombination to ensure data accuracy.

Performing a fraud analysis on the transaction using the reconstructed payment credential said payment credential 828 before sending it to said payment clearing system 166.

The step of receiving transaction authorization includes a multi-factor authentication process to validate the transaction.

Logging the transaction details in a secure transaction log within said sales system server 108 after receiving transaction authorization.

The secure erasure of the reconstructed payment credential from said bridge server 162 involves overwriting the data multiple times to prevent data recovery.

The following comprises a summary of the original claims to this application and is included to ensure that this application is fully enabled:

The method of securing commercial transactions 400 in the commercial transaction system 100, said method can comprise creating, using the customer device 120 and the sales system server 108, the customer account 508 associated with the customer 104a using the account creation procedure 402 comprising at least: receiving information related to said customer 104a in the basic account creation step 704, capturing the government ID image data 1604 in the ID scanning step 706, capturing the captured biometric data 1606 of said customer 104a during the facial scanning step 708, and comparing said government ID image data 1604 and said captured biometric data 1606 to verify a match related to said customer 104a, and creating the verification algorithm 1608 representing a verification of said customer 104a using said commercial transaction system 100. Creating the verification token 1806, using said customer device 120 and said sales system server 108, for a transaction associated with said customer 104a using the pre-transaction identity verification procedure 404 comprising at least: initiating a transaction, having the transaction data package 522, using said customer device 120, capturing an updated version of said captured biometric data 1606 using said customer device 120, performing a liveliness detection step to verify that said user can be physically present. Comparing, by said sales system server 108, said captured biometric data 1606 to said verification algorithm 1608 to verify the original party can be conducting said transaction, and providing the verification token 1806 provided said captured biometric data 1606 and said verification algorithm 1608 can be verified.

Storing user demographic data, name, address, or payment preferences in the customer account 508 of said user, ensuring compliance with know-your-customer (KYC) regulations.

Said capturing step includes using a camera on said customer device 120 to scan said government ID image data 1604 in the ID scanning step 706, and simultaneously capturing the captured biometric data 1606 of said customer 104a in the facial scanning step 708.

Verifying authenticity of said government ID image data 1604 by matching data from said identification document against a government or third-party database before storing said biometric profile.

Said biometric profile can be updated periodically to account for changes in a facial appearance of said customer 104a, said updates including a repeated facial scan validated by said sales system server 108.

Detecting a request to initiate a transaction from said user and comparing a new facial scan against said stored biometric profile to confirm user identity prior to payment approval.

Splitting the payment credential 828 associated with said user into the portion A 830 stored on said customer device 120 and the portion B 832 stored on said sales system server 108, and reconstructing said payment credential 828 only upon said confirmed user identity.

Said reconstructing step comprises retrieving the encryption key 834 from the key server 158, decrypting said portion A 830 and said portion B 832, and submitting a resulting combined credential to the payment clearing system 166.

Logging an account creation timestamp, user location, and verification details in the transaction log 602 to maintain a regulatory audit trail.

A method of use method of securing commercial transactions 400 in the commercial transaction system 100, said method can comprise detecting, by the sales system server 108, a trigger condition indicative of a high-risk or regulated transaction initiated by a user holding a previously created account. Prompting, at the customer device 120, said user to perform a pre-transaction identity verification including a live facial scan. Comparing, by said sales system server 108, said live facial scan to a stored biometric profile of said user created during the account creation procedure 402. Proceeding with a transaction approval process only if said stored biometric profile matches said live facial scan above a predetermined confidence threshold.

Said trigger condition comprises detection of at least one anomaly selected from the group consisting of unusual geographic location, excessive transaction frequency, or an abnormally large transaction amount.

A liveliness detection step wherein said customer device 120 captures multiple frames of said user's face, verifying motion or blinking before transmitting said live facial scan for comparison.

Said transaction approval process includes retrieving a newly generated verification token 1806 from said sales system server 108 and embedding said verification token 1806 in a payment request to confirm that said user was successfully verified.

Enabling a split-credential method, wherein said sales system server 108 reassembles the payment credential 828 only after validating said user's identity via said pre-transaction identity verification, then transmits an authorization request to the payment clearing system 166.

The commercial transaction system 100 configured to implement the method of securing commercial transactions 400 for pre-transaction identity verification, the system can comprise the customer device 120 having the device application 124 adapted to capture a user's facial image and transmit said facial image to the sales system server 108. Said sales system server 108 storing a biometric profile of said user in the identity verification database 608, said biometric profile having been generated during the account creation procedure 402. Wherein said sales system server 108 compares a newly captured facial image to said biometric profile upon detecting an attempted transaction, and authorizes said attempted transaction only if said newly captured facial image matches said biometric profile.

The key server 158 storing the encryption key 834, wherein said sales system server 108 and said customer device 120 employ a split-knowledge technique by dividing the payment credential 828 into the portion A 830 and the portion B 832, and reassembling said payment credential 828 upon receiving an indication that said user's facial verification has succeeded.

Said customer device 120 includes a liveliness detection module configured to prompt the user for minimal movements, said module analyzing captured image frames to ensure said user can be not presenting a static photograph or video replay.

A fraud detection module in said sales system server 108 configured to track transaction velocity, location anomalies, or repeated failed login attempts, and to trigger said pre-transaction identity verification if suspicious activity can be detected.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. A method of securing commercial transactions in a commercial transaction system, said method comprising:
creating, using a customer device and a sales system server, a customer account associated with a customer using an account creation procedure comprising at least:
receiving information related to said customer in a basic account creation step,
capturing a government ID image data in an ID scanning step,
capturing a captured biometric data of said customer during a facial scanning step, and
comparing said government ID image data and said captured biometric data to verify a match related to said customer, and
creating a verification algorithm representing a verification of said customer using said commercial transaction system;
creating a verification token, using said customer device and said sales system server, for a transaction associated with said customer using a pre-transaction identity verification procedure comprising at least:
initiating a transaction, having a transaction data package, using said customer device,
capturing an updated version of said captured biometric data using said customer device,
performing a liveliness detection step to verify that said user is physically present;
comparing, by said sales system server, said captured biometric data to said verification algorithm to verify the original party is conducting said transaction, and
providing the verification token provided said captured biometric data and said verification algorithm are verified.

2. The method of securing commercial transactions of claim 1, further comprising
storing user demographic data, name, address, or payment preferences in the customer account of said user, ensuring compliance with know-your-customer (KYC) regulations.

3. The method of securing commercial transactions of claim 1, wherein
said capturing step includes using a camera on said customer device to scan said government ID image data in the ID scanning step, and simultaneously capturing the captured biometric data of said customer in the facial scanning step.

4. The method of securing commercial transactions of claim 1, further comprising
verifying authenticity of said government ID image data by matching data from said identification document against a government or third-party database before storing said biometric profile.

5. The method of securing commercial transactions of claim 1, wherein
said biometric profile is updated periodically to account for changes in a facial appearance of said customer, said updates including a repeated facial scan validated by said sales system server.

6. The method of securing commercial transactions of claim 1, further comprising
detecting a request to initiate a transaction from said user and comparing a new facial scan against said stored biometric profile to confirm user identity prior to payment approval.

7. The method of securing commercial transactions of claim 6, further comprising
splitting a payment credential associated with said user into a portion A stored on said customer device and a portion B stored on said sales system server, and reconstructing said payment credential only upon said confirmed user identity.

8. The method of securing commercial transactions of claim 7, wherein,
said reconstructing step comprises retrieving an encryption key from a key server, decrypting said portion A and said portion B, and submitting a resulting combined credential to a payment clearing system.

9. The method of securing commercial transactions of claim 1, further comprising
logging an account creation timestamp, user location, and verification details in a transaction log to maintain a regulatory audit trail.

10. A method of use method of securing commercial transactions in a commercial transaction system, said method comprising:
detecting, by a sales system server, a trigger condition indicative of a high-risk or regulated transaction initiated by a user holding a previously created account;
prompting, at a customer device, said user to perform a pre-transaction identity verification including a live facial scan;
comparing, by said sales system server, said live facial scan to a stored biometric profile of said user created during an account creation procedure; and
proceeding with a transaction approval process only if said stored biometric profile matches said live facial scan above a predetermined confidence threshold.

11. The method of securing commercial transactions of claim 10, wherein
said trigger condition comprises detection of at least one anomaly selected from the group consisting of unusual geographic location, excessive transaction frequency, or an abnormally large transaction amount.

12. The method of securing commercial transactions of claim 10, further comprising
a liveliness detection step wherein said customer device captures multiple frames of said user's face, verifying motion or blinking before transmitting said live facial scan for comparison.

13. The method of securing commercial transactions of claim 10, wherein
said transaction approval process includes retrieving a newly generated verification token from said sales system server and embedding said verification token in a payment request to confirm that said user was successfully verified.

14. The method of securing commercial transactions of claim 10, further comprising
enabling a split-credential method, wherein said sales system server reassembles a payment credential only after validating said user's identity via said pre-transaction identity verification, then transmits an authorization request to a payment clearing system.

15. A commercial transaction system configured to implement a method of securing commercial transactions for pre-transaction identity verification, the system comprising:
a customer device having a device application adapted to capture a user's facial image and transmit said facial image to a sales system server;
said sales system server storing a biometric profile of said user in an identity verification database, said biometric profile having been generated during an account creation procedure; and
wherein said sales system server compares a newly captured facial image to said biometric profile upon detecting an attempted transaction, and authorizes said attempted transaction only if said newly captured facial image matches said biometric profile.

16. The commercial transaction system of claim 15, further comprising
a key server storing an encryption key, wherein said sales system server and said customer device employ a split-knowledge technique by dividing a payment credential into a portion A and a portion B, and reassembling said payment credential upon receiving an indication that said user's facial verification has succeeded.

17. The commercial transaction system of claim 15, wherein
said customer device includes a liveliness detection module configured to prompt the user for minimal movements, said module analyzing captured image frames to ensure said user is not presenting a static photograph or video replay.

18. The commercial transaction system of claim 15, further comprising
a fraud detection module in said sales system server configured to track transaction velocity, location anomalies, or repeated failed login attempts, and to trigger said pre-transaction identity verification if suspicious activity is detected.
